(19) United States
(12) Patent Application Publication
(10) Pub. No.: US 2002/0069419 A1
(43) Pub. Date: Jun. 6, 2002

(54) System and method for streaming video information to a user device

(76) Inventors: Pierre-Guillaume Raverdy, Santa Clara, CA (US); Nigel A.J. Davies, Lancaster (GB); Oliver D. Storz, Sankt Georgen (DE); Christos Efstratiou, Lancaster (GB)

Correspondence Address: Simon & Koerner LLP, 10052 Pasadena Avenue, Suite B, Cupertino, CA, 95014, US

(21) Appl. No.: 09/899,598

(22) Filed: Jul. 5, 2001

Related U.S. Application Data
(60) Provisional application No. 60/250,944, filed on Dec. 1, 2000.
(60) Provisional application No. 60/250,947, filed on Dec. 1, 2000.

(51) Int. Cl. H04N 7/173

(52) U.S. Cl. 725/87; 725/86; 725/91; 725/88; 725/93

(57) ABSTRACT

A system and method for streaming video information to a user device includes an event server that provides restricted access to various types of event content information and services related to a particular event. A wireless portable user device may provide an access code to the event server at a particular event location through a wireless base station that is coupled to a local area network. A system user may thereby utilize the user device to access the event server for downloading appropriate event content information and related services. The event content information may include a direct broadcast of streaming video produced by a video service provider from local video cameras positioned at the particular event. In addition, the event content information may include a plurality of event broadcasts that may be generated by the event server after receiving and storing program information from the local video cameras, the Internet, and various external program sources. The system user may also request individual video-on-demand services for downloading specific requested information from the event server.

### CROSS-REFERENCE TO RELATED APPLICATIONS

This application relates to, and claims priority in, U.S. Provisional Patent Application Serial No. 60/250,944, entitled “Infrastructure To Enhance User Experience At Live Events,” filed on Dec. 1, 2000, and to U.S. Provisional Patent Application Serial No. 60/250,947, entitled “Video Streaming To Personal Wireless Devices For Live Event Enhancement,” filed on Dec. 1, 2000. The foregoing related applications are commonly assigned, and are hereby incorporated by reference.

### BACKGROUND SECTION

1. Field of the Invention

This invention relates generally to techniques for accessing information, and relates more particularly to a system and method for streaming video information to a user device.

2. Description of the Background Art

Implementing effective methods for accessing information is a significant consideration for designers and manufacturers of contemporary electronic devices. However, effectively accessing information with electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that effectively accesses, stores, displays, and manipulates digital image data may benefit from an efficient implementation because of the large amount and complexity of the digital data involved.

Due to growing demands on system resources and substantially increasing data magnitudes, it is apparent that developing new techniques for accessing information is a matter of concern for related electronic technologies. Therefore, for all the foregoing reasons, developing effective systems for accessing information remains a significant consideration for designers, manufacturers, and users of contemporary electronic devices.

### SUMMARY

In accordance with the present invention, a system and method are disclosed for streaming video information to a user device. In one embodiment, an electronic system may preferably include, but is not limited to, at least one user device, a base station, a local area network (LAN), an event server, and an Internet network. A user device may preferably be implemented as any appropriate type of electronic device. For example, the user device may be configured as a portable wireless telecommunications device.

In certain embodiments, the user device may preferably communicate bidirectionally with the base station which may include a radio-frequency transceiver system to transmit and receive wireless communications to and from the user device. The base station may preferably be coupled to the LAN which may preferably be implemented at a particular event location. For example, the LAN and the base station may be located at a sporting venue or any other appropriate event locations. In certain embodiments, the electronic system may include multiple event servers and base stations coupled to one or more different LANs.

In one embodiment, the LAN may preferably communicate directly with the event server which may preferably include various types of event services or event content related to a particular event or event location. In another embodiment, the LAN may preferably include a computer device for connecting to the Internet which may then responsively communicate with the event server. In accordance with the present invention, the user device may thus access relevant event information from the event server via the LAN and the base station. In certain circumstances, the user device may also communicate directly with the Internet to access the event server.

In accordance with the present invention, the event server may preferably receive program information from various external entities. The program information may preferably include, but is not limited to, streaming video and other related information. In certain embodiments, the event server may preferably receive the program information from the Internet, one or more video cameras, and various other external program sources. The video cameras may include any type of video camera devices and any related equipment that may typically be positioned in various appropriate positions at a particular event location to capture video information corresponding to a particular event.

The external program sources may preferably include any appropriate sources of program information. For example, the program sources may include, but are not limited to, a satellite transmission source, a cable broadcasting source, a cellular telephone network, and a distributed computer network. The event server may preferably receive the program information from the Internet, video cameras, and program sources, and responsively store some or all of the received program information into a server memory as server content information.

The event server may preferably provide at least one direct broadcast through the base station to any user device that selects a corresponding direct broadcast channel. The direct broadcast may preferably include a sequence of streaming video information that is preferably produced in real time by a service provider at a particular event. The event server may also provide one or more event broadcasts through the base station to any user device that selects a corresponding event broadcast channel. The event broadcasts may include any desired type of program information. For example, an event broadcast channel may feature a series of highlights or replays from a particular event, while another event broadcast channel may feature one or more commentators discussing various strategic considerations for a particular event. The program information for event broadcasts may typically be retrieved from the server memory after initially being received from the Internet, the video cameras, and the external program sources.

The event server may also provide one or more channels of video-on-demand (VOD) through the base station to any user device that selects a corresponding VOD channel. In accordance with the present invention, VOD may include any desired type of program information. For example, a system user may utilize a user device to create and send a VOD request to the event server for requesting various alternate camera viewing angles from the video cameras. In response, the event server may service the VOD request and transmit the requested VOD information to the requesting user device via a corresponding VOD channel. The program information for VOD may typically be retrieved from the server memory after initially being received from the Internet, the video cameras, and the external program sources.

A user device may therefore flexibly select from a direct broadcast, one or more event broadcasts, and various types of VOD to thereby significantly enhance the viewing experience at a particular event. The present invention thus provides an improved system and method for streaming video information to a user device.

### BRIEF DESCRIPTION OF THE DRAWINGS

FIG. 1 is a block diagram of an electronic system, in accordance with one embodiment of the present invention;

FIG. 2 is a block diagram for one embodiment of the user device of FIG. 1, in accordance with the present invention;

FIG. 3 is a block diagram for one embodiment of the device memory of FIG. 2, in accordance with the present invention;

FIG. 4 is a block diagram for one embodiment of the user data of FIG. 3, in accordance with the present invention;

FIG. 5 is a block diagram for one embodiment of the event server of FIG. 1, in accordance with the present invention;

FIG. 6 is a block diagram for one embodiment of the server memory of FIG. 5, in accordance with the present invention;

FIG. 7 is a block diagram illustrating a video streaming procedure, in accordance with the present invention;

FIG. 8 is a flowchart of method steps for streaming video information to a user device, in accordance with one embodiment of the present invention;

FIG. 9 is a flowchart of method steps for selecting a viewing mode, in accordance with one embodiment of the present invention;

FIG. 10 is a flowchart of method steps for a broadcast viewing mode, in accordance with one embodiment of the present invention;

FIG. 11 is a flowchart of method steps for a VOD viewing mode, in accordance with one embodiment of the present invention; and

FIG. 12 is a flowchart of method steps for a local viewing mode, in accordance with one embodiment of the present invention.

### DETAILED DESCRIPTION

The present invention relates to an improvement in information management techniques. The following description is presented to enable one of ordinary skill in the art to make and use the invention and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for streaming video information to a user device, and may preferably include an event server that provides restricted access to various types of event content information and services related to a particular event. A wireless portable user device may provide an access code to the event server at a particular event location through a wireless base station that is coupled to a local area network. A system user may thereby utilize the user device to access the event server for downloading appropriate event content information and related services.

The event content information may include a direct broadcast of streaming video produced by a video service provider from local video cameras positioned at the particular event. In addition, the event content information may include a plurality of event broadcasts that may be generated by the event server after receiving and storing program information from the local video cameras, the Internet, and various external program sources. The system user may also request individual video-on-demand services for downloading specific requested information from the event server.

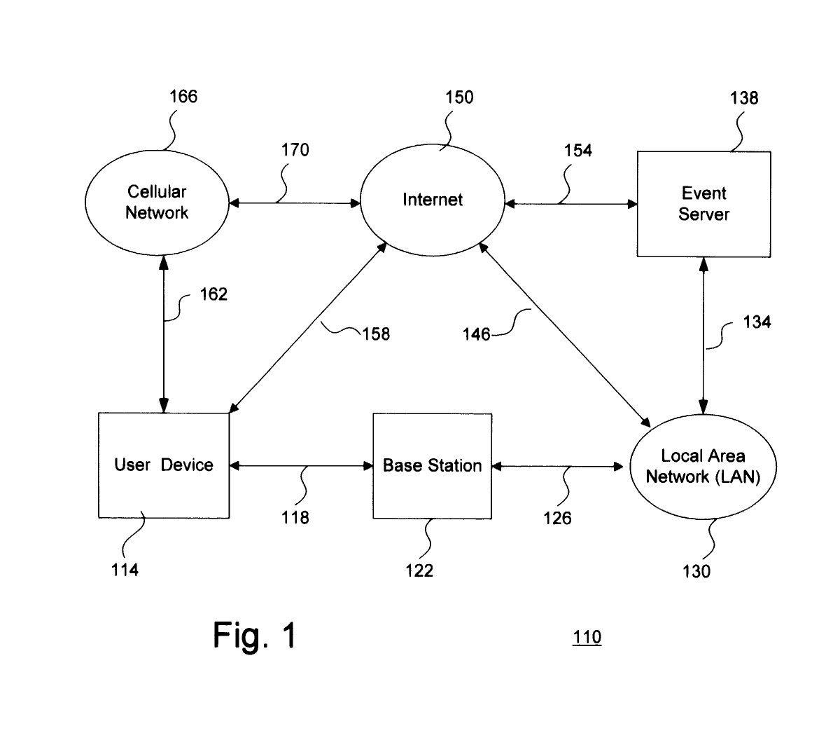

Referring now to FIG. 1, a block diagram of an electronic system 110 is shown, in accordance with one embodiment of the present invention. In the FIG. 1 embodiment, electronic system 110 may preferably include, but is not limited to, a user device 114, a base station 122, a local area network (LAN) 130, an event server 138, an Internet network 150, and a cellular network 166. In alternate embodiments, electronic system 110 may readily be implemented using various components and configurations in addition to, or instead of, those discussed in conjunction with the FIG. 1 embodiment. For example, in certain embodiments, electronic system 110 may readily be configured to include multiple base stations 122 and/or multiple event servers 138.

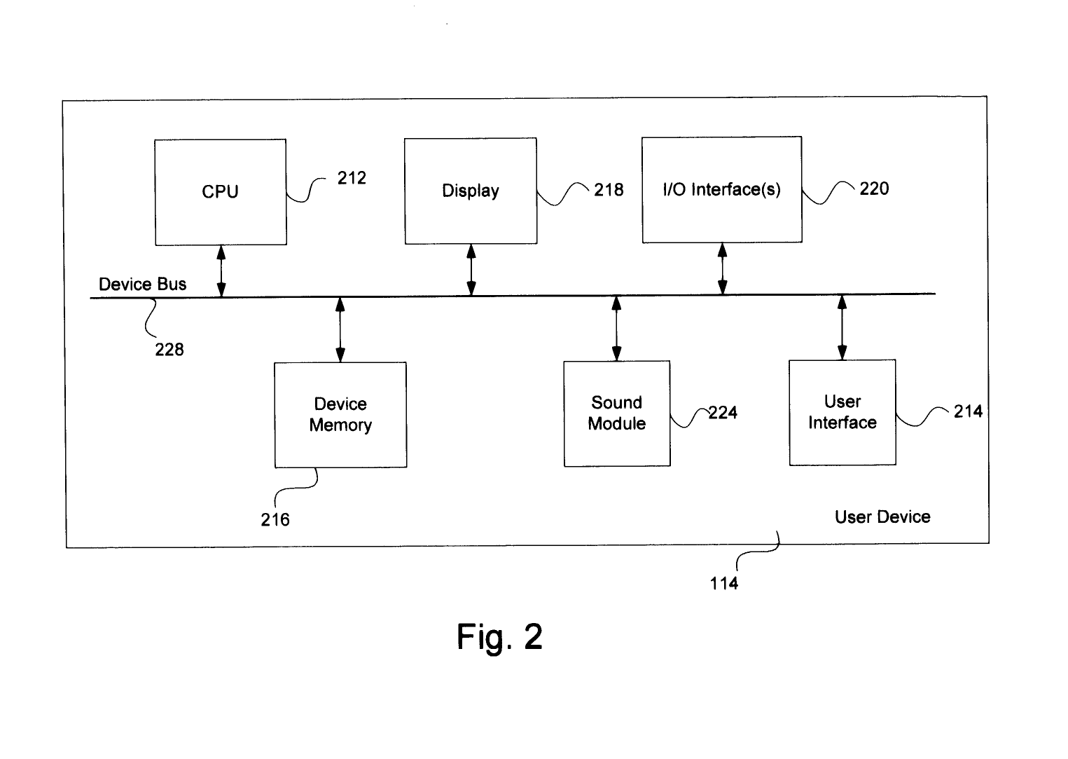

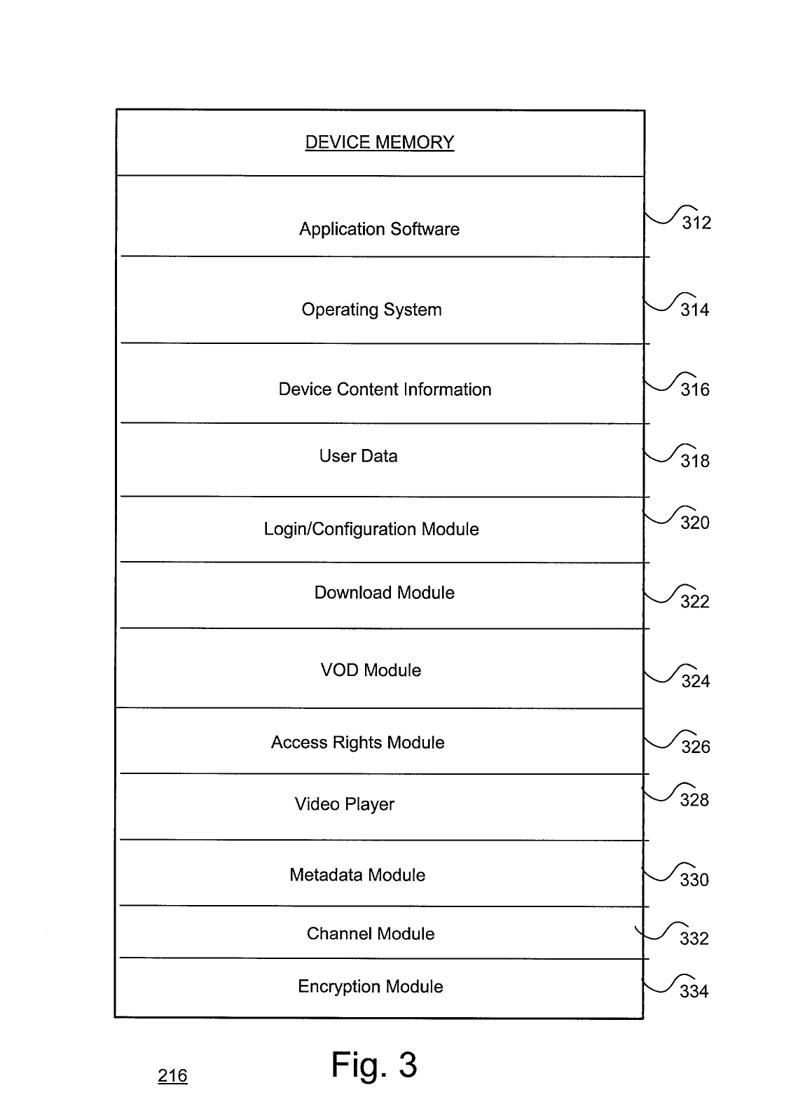

In the FIG. 1 embodiment, user device 114 may preferably be implemented as any appropriate type of electronic device. For example, user device 114 may be configured as a portable wireless telecommunications device. The configuration and functionality of user device 114 is further discussed below in conjunction with FIGS. 2 and 3.

In the FIG. 1 embodiment, user device 114 may preferably communicate bidirectionally with base station 122 via path 118. Base station 122 may preferably be implemented in any appropriate manner. For example, base station 122 may include a radio-frequency transceiver system to transmit and receive wireless communications to and from user device 114. Base station 122 may preferably be coupled to LAN 130 via path 126.

In the FIG. 1 embodiment, LAN 130 may preferably be implemented at a particular event location. For example, LAN 130 and base station 122 may be located at a sporting venue or any other similar live spectator event. In certain embodiments, electronic system 110 may include multiple base stations 122 coupled to one or more different LANs 130.

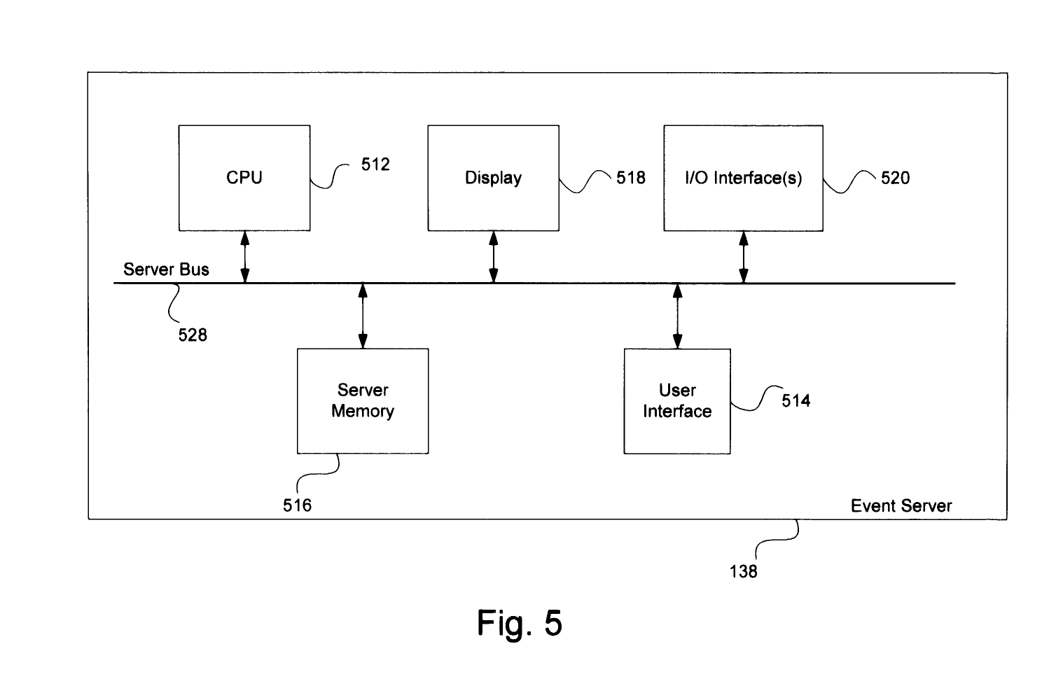

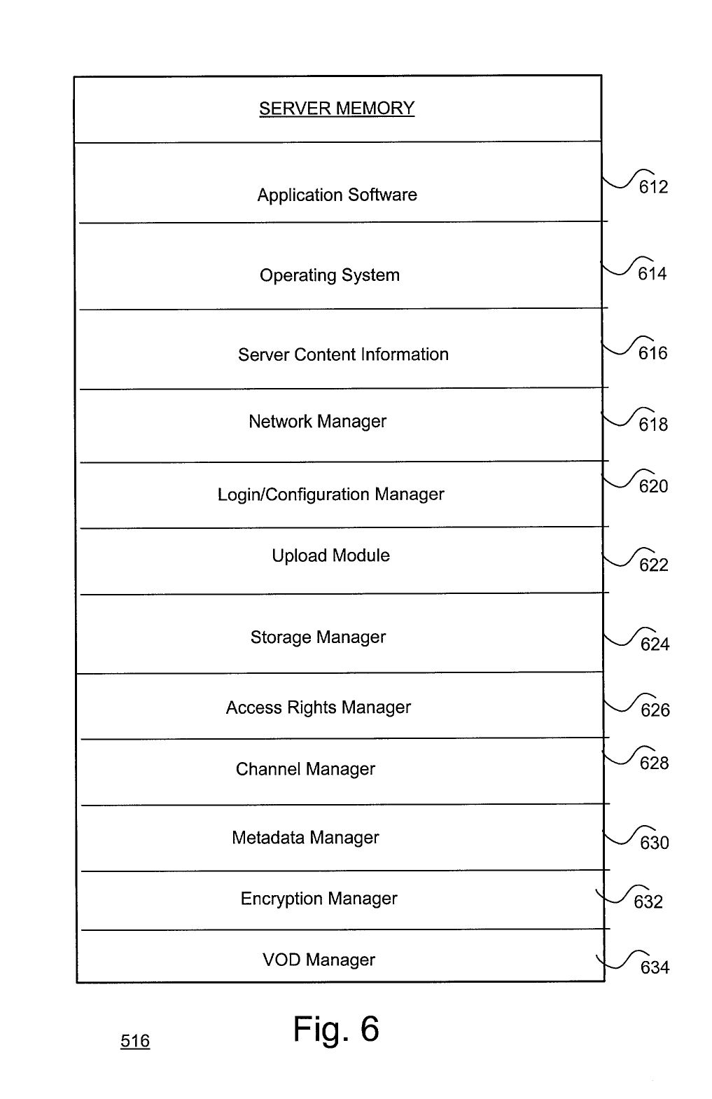

In the FIG. 1 embodiment, LAN 130 may preferably communicate directly with event server 138 via path 134. Event server 138 may preferably include various types of event services or event information related to a particular event or event location. In certain embodiments, LAN 130 may preferably include a computer device (not shown) for connecting to Internet 150 via path 146. Internet 150 may then responsively communicate with event server 138 via path 154. The implementation and functionality of event server 138 is further discussed below in conjunction with FIGS. 5 and 6.

In accordance with the present invention, user device 114 may thus access relevant event information from event server via base station 122 and LAN 130. In certain circumstances, user device 114 may also communicate directly with Internet 150 via path 158 to access event server 138. For example, user device 114 may be utilized to access event server 138 before or after attending a particular event location. In addition, user device 114 may also communicate with cellular network 166 via path 162 to thereby access Internet 150 and event server 138 via path 170.

Referring now to FIG. 2, a block diagram for one embodiment of the FIG. 1 user device 114 is shown, in accordance with the present invention. In the FIG. 2 embodiment, user device 114 preferably includes, but is not limited to, a central processing unit (CPU) 212, a user interface 214, a device memory 216, a display 218, one or more input/output interface(s) (I/O interface(s)) 220, and a sound module 224. The foregoing components of user device 114 may preferably be coupled to, and communicate through, a device bus 228.

In alternate embodiments, user device 114 may readily be implemented using various components and configurations in addition to, or instead of, those discussed in conjunction with the FIG. 2 embodiment. In addition, user device 114 may be implemented as any desired type of electronic device. For example, in certain embodiments, user device 114 may include a personal digital assistant (PDA) device, a cellular telephone device, a computer device, or any portable electronic device that supports wireless electronic communications.

In the FIG. 2 embodiment, CPU 212 may be implemented to include any appropriate and compatible microprocessor device that preferably executes software instructions to thereby control and manage the operation of user device 114. The FIG. 2 display 218 preferably may include any effective type of display technology including a cathode-ray-tube monitor or a liquid-crystal display device.

In the FIG. 2 embodiment, I/O interface(s) 220 preferably may include one or more input and/or output interfaces to receive and/or transmit any required types of information by user device 114. For example, in the FIG. 2 embodiment, user device 114 may utilize I/O interface(s) 220 to bi-directionally communicate with various types of wireless communications devices through a wireless communications interface. The wireless communications interface may preferably include any effective means to remotely communicate with an external entity such as LAN 130 (FIG. 1) or Internet 150, to thereby exchange relevant information for successful operation of user device 114.

In addition, user device 114 may utilize the wireless communications interface to download various types of content information and other data from a wireless source such as base station 122 (FIG. 1). The foregoing wireless communications interface may be implemented using any appropriate wireless technology, including radio-frequency transmission, infrared transmission, or microwave transmission.

In the FIG. 2 embodiment, user device 114 may also utilize I/O interface(s) 220 to bi-directionally communicate with one or more distributed computer networks. For example, user device 114 may advantageously communicate with the Internet, a local area network, or other distributed computer networks to upload or download various types of information.

User device 114 may also utilize I/O interface(s) 220 to bi-directionally communicate with a host computer. For example, user device 114 may communicate with a personal computer device over a Universal Serial Bus (USB) to effectively upload or download various types of information. Similarly, in the FIG. 2 embodiment, user device 114 may utilize I/O interface(s) 220 to bi-directionally communicate with a cellular telephone network to preferably transfer any desired information.

In the FIG. 2 embodiment, one or more removable storage media interfaces may preferably be utilized to receive or send any desired data for user device 114. For example, various types of removable storage media may provide means for bi-directional transfers of content information and other data between user device 114 and other appropriate entities. In certain embodiments, the removable storage media may include memory devices to support any desired type or combination of removable storage media. For example, the removable storage media may support memory sticks, flash memory devices, compact disks, mini-disks, or floppy disks.

In the FIG. 2 embodiment, device memory 216 may be implemented to include any combination of desired storage devices, including, but not limited to, read-only memory (ROM), random-access memory (RAM), and various types of non-volatile memory, such as floppy disks or hard disks. The contents and functionality of device memory 216 are further discussed below in conjunction with FIG. 3.

Sound module 224 preferably may include appropriate interfaces to support audio functionality for user device 114. For example, in certain embodiments, sound module 224 may include, but is not limited to, an audio processing module, a power amplifier, one or more speaker devices, and a microphone device.

In the FIG. 2 embodiment, user interface 214 may preferably include any effective means to allow a system user to communicate with user device 114. For example, user interface 214 may support a keyboard device, a wireless remote control device, a speech-recognition module with corresponding microphone, a graphical user interface with touch-screen capability, or a selection button array mounted externally on user device 114.

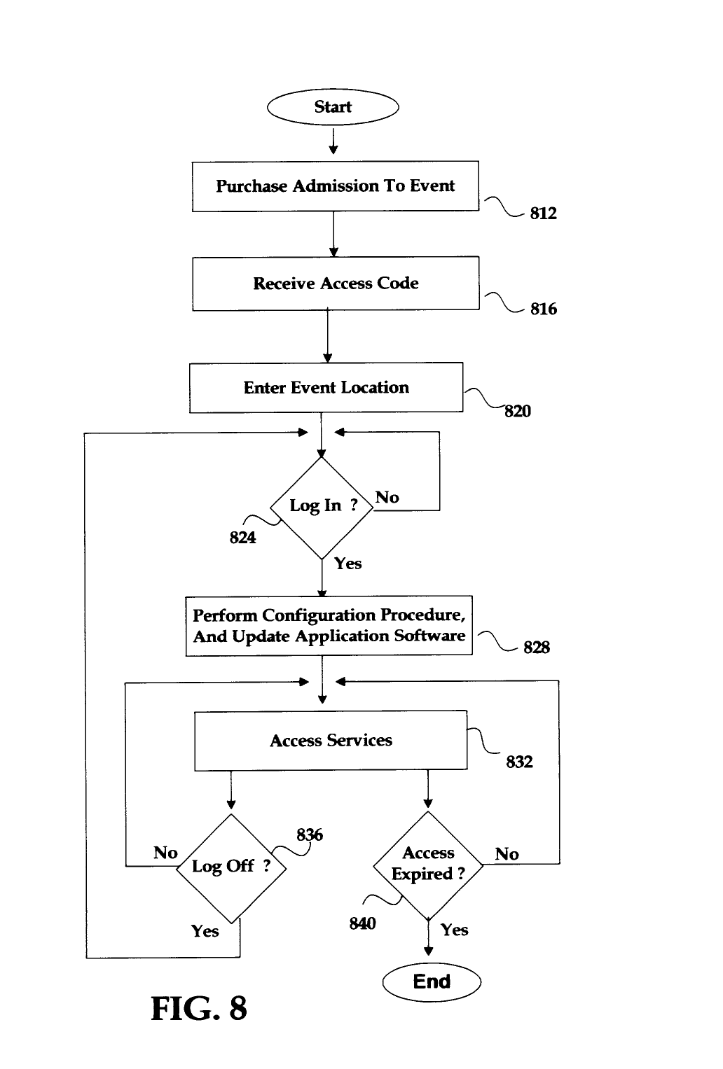

In the FIG. 2 embodiment, user interface 214 may preferably also include any effective means to allow a system user to select from a plurality of program channels. For example, a system user may utilize user device 114 to selectively access video and other information by viewing various selection choices on display 218 and then responsively utilizing user interface 214 to select an appropriate program channel for receiving and viewing corresponding content information from event server 138. The functionality and utilization of user device 114 is further discussed below in conjunction with FIGS. 8-12.

Referring now to FIG. 3, a block diagram for one embodiment of the FIG. 2 device memory 216 is shown, in accordance with the present invention. In the FIG. 3 embodiment, device memory 216 preferably includes, but is not limited to, application software 312, an operating system 314, device content information 316, user data 318, a login/configuration module 320, a download module 322, a video-on-demand (VOD) module 324, an access rights module 326, a video player 328, a metadata module 330, a channel module 332, and an encryption module 334. In alternate embodiments, device memory 216 may readily include various other components in addition to, or instead of, those components discussed in conjunction with the FIG. 3 embodiment.

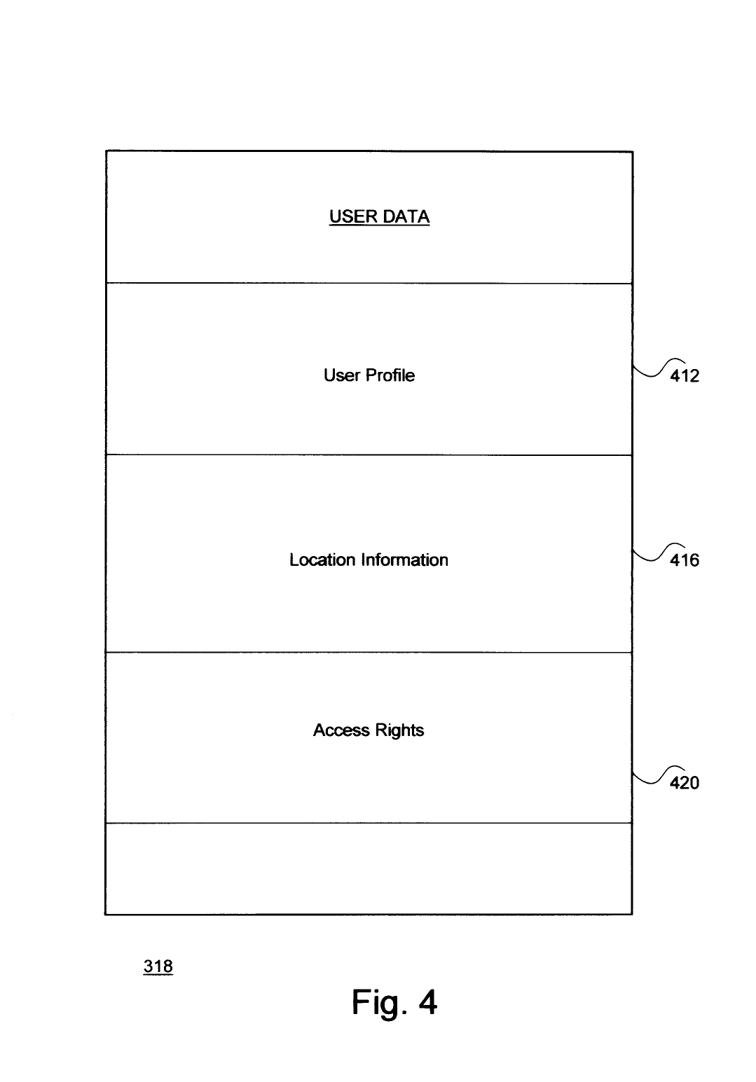

In the FIG. 3 embodiment, application software 312 may include program instructions that are preferably executed by CPU 212 (FIG. 2) to perform various functions and operations for user device 114. The particular nature and functionality of application software 312 preferably varies depending upon factors such as the specific type and particular use of the corresponding user device 114. In the FIG. 3 embodiment, operating system 314 preferably controls and coordinates low-level functionality of user device 114. Device content information 316 preferably includes various types of event content that is preferably stored in device memory 216. Device content information 316 preferably may include various types of image data or other types of information. For example, device content information 316 may include various types of streaming video information. User data 318 may preferably include any information pertaining to the utilization of user device 114 by one or more system users. User data 318 is further discussed below in conjunction with FIG. 4.

In the FIG. 3 embodiment, login/configuration module 320 may preferably initiate bi-directional communications between user device 114 and another entity in electronic system 110. For example, login/configuration module 320 may perform a login procedure to initially connect user device 114 to event server 138 via LAN 130 or via Internet 150. In the FIG. 3 embodiment, login/configuration module 320 may preferably initially provide an access code and other user data 318 to event server 138 which may responsively send appropriate configuration information to user device 114. Login/configuration module 320 may then perform a configuration procedure by utilizing the downloaded configuration information from event server 138 to effectively configure user device 114 in an optimal manner for accessing event server 138 in conjunction with a particular event at a corresponding event location.

In the FIG. 3 embodiment, download module 324 may preferably download and install appropriate application software 312 or other software modules for use at a particular event or event location. Download module 324 may also initially determine whether a version of the application software 312 or other software modules already exists on user device 114, and may then perform an update procedure if the current version of application software 312 or other software modules is outdated.

In the FIG. 3 embodiment, VOD module 324 may preferably create a VOD request in response to system user input. In the FIG. 3 embodiment, access rights module 326 may preferably communicate with event server 138 regarding access rights of user device 114. For example, access rights module 326 may preferably receive one or more time-stamped access capabilities for various services on event server 138. Access rights are further discussed below in conjunction with FIGS. 4 and 8.

In the FIG. 3 embodiment, video player 328 may preferably support receiving, processing, and displaying various types of streaming video information from event server 138. Similarly, metadata module 330 may preferably support receiving, processing, synchronizing, and displaying various types of metadata information from event server 138. For example, metadata module 330 may manage and provide various types of ancillary information that is related to a particular event, such as event participant statistics or other background information.

In the FIG. 3 embodiment, channel module 332 may preferably communicate with event server 138 to manage program channels for transmitting various program information to user device 114. For example, channel module 332 may determine which program channels and program sources are currently available for selection by user device 114. Channel module 332 may also set up specific connection information between event server 138 and user device 114. Encryption module 334 may preferably perform a decryption procedure to decode program information that has been encrypted by event server 138 prior to transmission to user device 114. Encryption module 334 may also receive an encryption key for decrypting content information that has been encrypted by event server 138 prior to transmission to user device 114.

Referring now to FIG. 4, a block diagram for one embodiment of the FIG. 3 user data 318 is shown, in accordance with the present invention. In the FIG. 4 embodiment, user data 318 may include, but is not limited to, one or more user profiles 412, location information 416, and access rights 420. In alternate embodiments, user data 318 may readily include various other components in addition to, or instead of, those components discussed in conjunction with the FIG. 4 embodiment.

In the FIG. 4 embodiment, user profiles 412 may include any information related to a system user of user device 114. In the FIG. 4 embodiment, location information 416 may preferably include any relevant information pertaining to one or more particular event locations. Location information 416 may be obtained in any suitable manner. For example, location information 416 may be provided by a system user by utilizing user interface 214 (FIG. 2). In accordance with the present invention, location information 416 may be provided to event server 138 in order to facilitate access to appropriate services and content information related to a corresponding event location.

In the FIG. 4 embodiment, access rights 420 may include one or more access codes for logging onto event server 138. Access codes may be obtained in any effective manner. For example, a system user may obtain an access code when purchasing admission to a particular event, and may responsively enter the access code using user interface 214. Alternately, an access code may be electronically transferred to user device 114. For example, a wireless “beaming” technique may utilize infrared or radio-frequency transmission to provide an access code to user device 114. Each of the foregoing access codes may preferably be associated with one or more time-stamped access capabilities for accessing corresponding services and content information from event server 138. Access rights to various types of server content information is further discussed below in conjunction with FIG. 8.

Referring now to FIG. 5, a block diagram for one embodiment of the FIG. 1 event server 138 is shown, in accordance with the present invention. In the FIG. 5 embodiment, event server 138 preferably includes, but is not limited to, a central processing unit (CPU) 512, a user interface 514, a server memory 516, a display 518, and one or more input/output interface(s) (I/O interface(s)) 520. The foregoing components of event server 138 may preferably be coupled to, and communicate through, a server bus 528.

In alternate embodiments, event server 138 may readily be implemented using various components and configurations in addition to, or instead of, those discussed in conjunction with the FIG. 5 embodiment. In certain embodiments, event server 138 may be configured as a series of computer devices that each receive, process, and transmit one or more different video information streams or other related information to one or more user devices 114.

In the FIG. 5 embodiment, CPU 512 may be implemented to include any appropriate and compatible microprocessor device that preferably executes software instructions to thereby control and manage the operation of event server 138. The FIG. 5 display 518 preferably may include any effective type of display technology including a cathode-ray-tube monitor or a liquid-crystal display device.

In the FIG. 5 embodiment, I/O interface(s) 520 preferably may include one or more input and/or output interfaces to receive and/or transmit any required types of information by event server 138. For example, in the FIG. 5 embodiment, event server 138 may utilize I/O interface(s) 520 to bi-directionally communicate with various types of wireless communications devices through a wireless communications interface. The wireless communications interface may preferably include any effective means to remotely communicate with an external entity such as LAN 130 (FIG. 1) or Internet 150, to thereby exchange relevant information for successful operation of event server 138.

In addition, event server 138 may utilize the wireless communications interface to download various types of information and other data from a wireless source such as user device 114 (FIG. 1). The foregoing wireless communications interface may be implemented using any appropriate wireless technology, including radio-frequency transmission, infra-red transmission, or micro-wave transmission.

In the FIG. 5 embodiment, event server 138 may also utilize I/O interface(s) 520 to bi-directionally communicate with one or more distributed computer networks. For example, event server 138 may advantageously communicate with the Internet, a local area network such as LAN 130, or other distributed computer networks to upload or download various types of information.

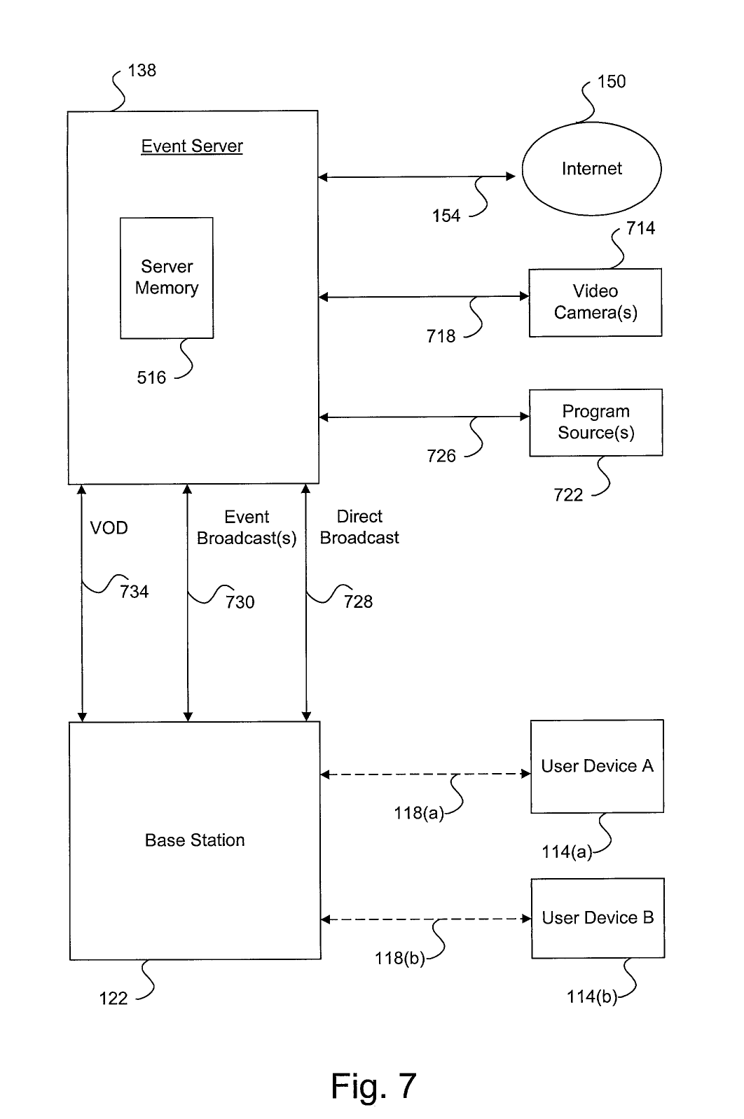

In the FIG. 5 embodiment, I/O interface(s) 520 may preferably include appropriate means for receiving and locally storing streaming video and other information from one or more external program sources. I/O interface(s) 520 may also preferably include appropriate means for transmitting the stored video and other information to user devices 114 via one or more program channels. In the FIG. 5 embodiment, I/O interface(s) 520 may preferably also include a series of program channels and a channel switching mechanism by which a given user device 114 may selectively choose to receive video or other information from a given program source via a particular program channel. The configuration and utilization of certain I/O interface(s) 520 of event server 138 is further discussed below in conjunction with FIG. 7.

In the FIG. 5 embodiment, server memory 516 may be implemented to include any combination of desired storage devices, including, but not limited to, read-only memory (ROM), random-access memory (RAM), and various types of non-volatile memory, such as floppy disks or hard disks. The contents and functionality of server memory 516 are further discussed below in conjunction with FIG. 6.

In the FIG. 5 embodiment, user interface 514 may preferably include any effective means to allow a system user to communicate with event server 138. For example, user interface 514 may support a keyboard device, a display device, and/or other devices. The functionality and utilization of event server 138 is further discussed below in conjunction with FIGS. 8-12.

Referring now to FIG. 6, a block diagram for one embodiment of the FIG. 5 server memory 516 is shown, in accordance with the present invention. In the FIG. 6 embodiment, server memory 516 preferably includes, but is not limited to, application software 612, an operating system 614, server content information 616, network manager 618, a login/configuration manager 620, an upload module 622, a storage manager 624, an access rights manager 626, a channel manager 628, a metadata manager 630, an encryption manager 632, and a VOD manager 634. In alternate embodiments, server memory 516 may readily include various other components in addition to, or instead of, those components discussed in conjunction with the FIG. 6 embodiment.

In the FIG. 6 embodiment, application software 612 may include program instructions that are preferably executed by CPU 512 (FIG. 5) to perform various functions and operations for event server 138. The particular nature and functionality of application software 612 preferably varies depending upon factors such as the specific type and particular use of the corresponding event server 138. In the FIG. 6 embodiment, operating system 614 preferably controls and coordinates low-level functionality of event server 138. Server content information 616 preferably includes various types of event content that are preferably stored in server memory 516. For example, server content information 616 may preferably include streaming video and other information that may be received from any appropriate program source. In the FIG. 6 embodiment, network manager 618 may preferably cooperate with channel manager 628 and VOD manager 634 to manage available bandwidth and available resources for the various program channels from event server 138 to various user devices 114 in electronic system 110.

In the FIG. 6 embodiment, login/configuration manager 620 may preferably manage bi-directional communications between event server 138 and another entity in electronic system 110. For example, login/configuration manager 620 may participate in a login procedure to initially connect a user device 114 to event server 138 via LAN 130 or via Internet 150 (see FIG. 1). In the FIG. 6 embodiment, login/configuration manager 620 may preferably initially receive an access code and other user data 318 from a user device 114. Login/configuration manager 620 may then preferably participate in a configuration procedure by responsively providing appropriate configuration information to the particular user device 114. The user device 114 may then utilize the configuration information to effectively configure the user device 114 in an optimal manner for accessing event server 138 in conjunction with a particular event at a corresponding event location. In the FIG. 6 embodiment, upload module 622 may preferably provide appropriate device application software 312 (FIG. 2) or other device software for use at a particular event or event location to user device 114.

In the FIG. 6 embodiment, storage manager 624 may preferably store and retrieve streaming video and other information to and from server content information 616 of server memory 516. In the FIG. 6 embodiment, access rights manager 626 may preferably communicate with user device 114 regarding access rights of a particular system user. For example, access rights manager 626 may preferably provide one or more time-stamped access capabilities to user device 114 for various services on event server 138. Access rights manager 626 may also provide an encryption key for decrypting content information that has been encrypted by event server 138 prior to transmission to user device 114. Access rights to server content information 616 are further discussed below in conjunction with FIG. 8.

In the FIG. 6 embodiment, channel manager 628 may preferably support processing and transmitting various types of streaming video information from event server 138 to user devices 114 via appropriate program channels. Metadata manager 630 may preferably support extracting, processing, synchronizing, and transmitting various types of metadata information from event server 138. For example, metadata manager 630 may manage and provide various types of ancillary information that is related to a particular event, such as event participant statistics or other background information.

In the FIG. 6 embodiment, encryption manager 632 may preferably perform an encryption procedure on video and other information before transmission to user devices 114. Encryption manager 632 may utilize any effective encryption methodology or technique depending upon particular security and other considerations. VOD manager 634 may preferably cooperate with storage manager 624 and metadata manager 630 to effectively service VOD requests from user devices 114.

Referring now to FIG. 7, a block diagram illustrating a video streaming procedure is shown, in accordance with the present invention. In alternate embodiments of the present invention, streaming video information may readily be performed by utilizing various other architectures and configurations, and may also include various items and components that are different from those discussed in conjunction with the FIG. 7 embodiment.

In accordance with the present invention, event server 138 may preferably receive program information from various external entities. The program information may preferably include, but is not limited to, streaming video and other related information. In the FIG. 7 embodiment, event server 138 may receive the program information from the Internet 150 via path 154, from one or more video cameras 714 via path 718, and from various program sources 722 via path 726.

In the FIG. 7 embodiment, video cameras 714 may include any type of video camera devices and any related equipment that may typically be positioned in various appropriate positions at a particular event location to capture video information corresponding to a particular event. In the FIG. 7 embodiment, video cameras 714 may be controlled by a particular video service provider, such as a television broadcasting company or television network.

In the FIG. 7 embodiment, program source(s) 722 may preferably include one or more appropriate sources of program information. For example, program source(s) may include, but are not limited to, a satellite transmission source, a cable broadcasting source, a cellular telephone network, and a distributed computer network.

In the FIG. 7 embodiment, event server 138 may preferably receive various program information from the Internet 154, video cameras 714, and program sources 722, and responsively store some or all of the received program information into server memory 516 as server content information 616 (FIG. 6). In addition, event server 138 may preferably provide at least one direct broadcast 728 through base station 122 to any user device 114 that selects a corresponding direct broadcast channel. In the FIG. 7 embodiment, the foregoing direct broadcast 728 may preferably include a sequence of streaming video information that is preferably produced in real time by a service provider at a particular event.

In the FIG. 7 embodiment, event server 138 may also provide one or more event broadcast(s) 730 through base station 122 to any user device 114 that selects a corresponding event broadcast channel. In accordance with the present invention, event broadcasts 730 may include any desired type of program information. For example, an event broadcast channel may feature a series of highlights or replays from a particular event, while another event broadcast channel may feature one or more commentators discussing various strategic considerations for a particular event. In certain embodiments, user device 114 may store the foregoing series of highlights or replays into a local device memory 216 (FIG. 2) for subsequent viewing by the system user. In the FIG. 7 embodiment, program information for event broadcasts 730 may typically be retrieved from server memory 516 after initially being received from the Internet 150, video cameras 714, and program sources 722.

In the FIG. 7 embodiment, event server 138 may also provide one or more channels of video-on-demand (VOD) 734 through base station 122 to any user device 114 that selects a corresponding VOD channel. In accordance with the present invention, VOD 734 may include any desired type of program information. For example, a system user may utilize a user device 114 to create and send a VOD request to event server 138 to thereby request various alternate camera viewing angles from video cameras 714. In response, event server 138 may service the request and transmit the requested VOD to the requesting user device 114 via a corresponding VOD channel. In the FIG. 7 embodiment, program information for VOD 734 may typically be retrieved from server memory 516 after initially being received from the Internet 150, video cameras 714, and program sources 722.

In the FIG. 7 embodiment, event server 138 may preferably monitor all VOD requests from system users of user devices 114. When a sufficient number of system users request the same or similar VOD 734, then event server 138 may dynamically create a new event broadcast 730 for that particular VOD request to advantageously conserve channel bandwidth. Event server 138 may also notify system users regarding creation of the new event broadcast 730.

In the FIG. 7 embodiment, a user device A 114(a) may therefore flexibly select from direct broadcast 728, event broadcasts 730, and VOD 734 to thereby significantly enhance the viewing experience at a particular event. User device A 114(a) may then receive a corresponding direct broadcast channel, event broadcast channel, or VOD channel from base station 122 via wireless path 118(a). Similarly, a user device B 114(b) may flexibly select from direct broadcast 728, event broadcasts 730, and VOD 734 to enhance the viewing experience at the particular event. User device B 114(b) may then receive a corresponding direct broadcast channel, event broadcast channel, or VOD channel from base station 122 via wireless path 118(b).

In alternate embodiments, event server 138 may support any number of channels, base stations 122, or user devices 114. In addition, although foregoing FIG. 5 shows event server 138 implemented as a single computer device, in certain alternate embodiments, event server 138 may readily be implemented to include a plurality of computer devices that each cooperate to effectively service one or more direct broadcast channels, event broadcast channels, or VOD channels.

Referring now to FIG. 8, a flowchart of method steps for selectively providing information to a user device 114 is shown, in accordance with one embodiment of the present invention. The FIG. 8 example is presented for purposes of illustration, and, in alternate embodiments, the present invention may readily utilize various other steps and sequences than those discussed in conjunction with the FIG. 8 embodiment.

In the FIG. 8 embodiment, initially, in step 812, a system user may preferably purchase an admission to a particular event or event location. Then, in step 816 the system user may preferably receive an access code corresponding to the particular event or event location. In step 820, the system user may preferably enter the event location.

Next, in step 824, the system user may preferably determine whether to perform a login procedure with user device 114 to thereby gain access to event server 138. During the login procedure, user device 114 may preferably provide the foregoing access code received in step 816 to event server 138. In certain embodiments, user device 114 may also provide other user data 318 to event server 138.

In step 828, user device 114 may preferably perform a configuration procedure with configuration information downloaded from event server 138. In addition, when appropriate, user device 114 may also update application software 312 or other software module in user device 114 to correspond to a latest software version for the event or event location. Then, in step 832, user device 114 may preferably access and utilize various services and content information from event server 138. In the FIG. 8 embodiment, event server 138 may preferably regulate access to various services and content information based upon time-stamped access capabilities corresponding to the access code provided by user device 114 to event server 138 during the foregoing login procedure. In certain embodiments, a system user may utilize user device 114 to provide various types of user feedback to event server 138 regarding a current event or event location. In addition, a system user may also communicate with event server 138 to perform various event-related activities such as ordering admission tickets or event notifications for future events.

In step 836, the system user may preferably determine whether to perform a logoff procedure with user device 114 to thereby terminate access to event server 138. If the system user determines to perform a logoff procedure, then the FIG. 8 process may preferably return to foregoing step 824 until the system user initiates another login procedure. Alternately, in step 840, event server 138 may periodically determine whether access rights for the user device 114 have expired. In the FIG. 8 embodiment, access rights manager 626 of event server 138 may preferably monitor the time-stamped access capabilities of access rights 420 (FIG. 4) to determine whether the access rights of the particular user device 114 have expired. In the FIG. 8 embodiment, when event server 138 determines that the access rights of the particular user device 114 have expired, then the FIG. 8 process may preferably terminate.

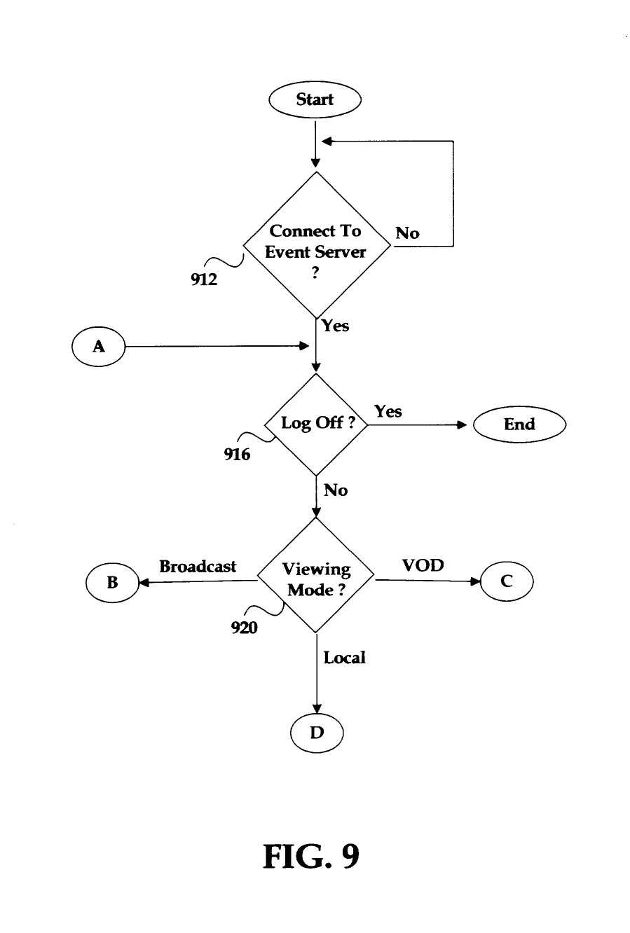

Referring now to FIG. 9, a flowchart of method steps for selecting a viewing mode is shown, in accordance with one embodiment of the present invention. The FIG. 9 example is presented for purposes of illustration, and in alternate embodiments, the present invention may readily utilize various other steps and sequences than those discussed in conjunction with the FIG. 9 embodiment.

FIGS. 9-12 together may form a single embodiment for an integrated method of streaming video and other information to a user device, in accordance with the present invention. However, for purposes of clarity, FIGS. 9-12 are presented herein as separate flowcharts that are linked together by alphabetical connection symbols. In addition, in certain embodiments of the present invention, the starting point of the FIG. 9 method may preferably occur during step 832 of foregoing FIG. 8, during which a user device 114 accesses various services from event server 138.

In the FIG. 9 embodiment, in step 912, user device 114 may preferably determine whether a system user has connected to event server 138 by utilizing user device 114. In step 916, after connecting to event server 138, user device 114 may then determine whether the system user has logged off the connection to event server 138. If the system user has logged off the connection to event server 138, then the FIG. 9 process may preferably terminate. However, if the system user has not logged off the connection to event server 138, then in step 920, the system user may utilize any appropriate means to select a viewing mode for utilizing user device 114.

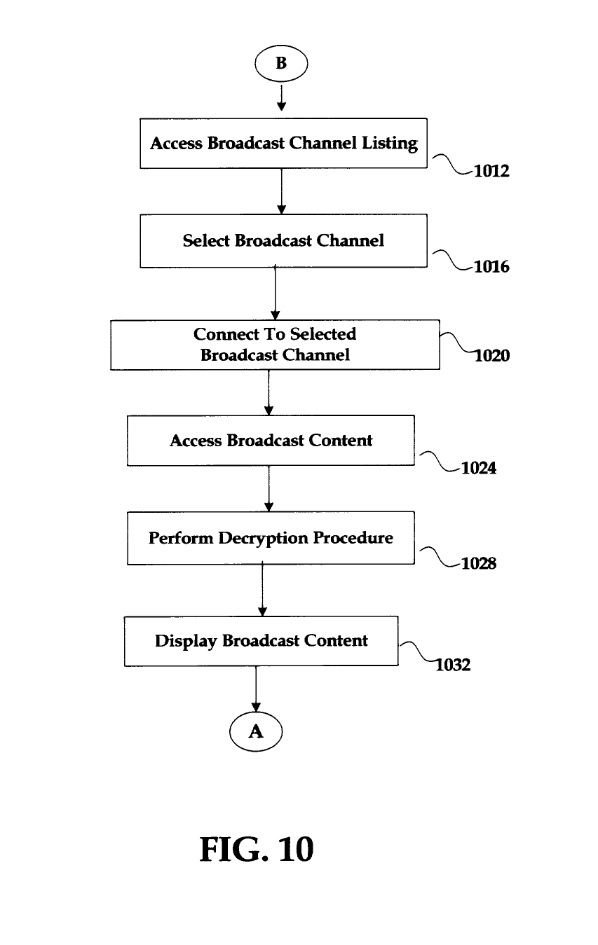

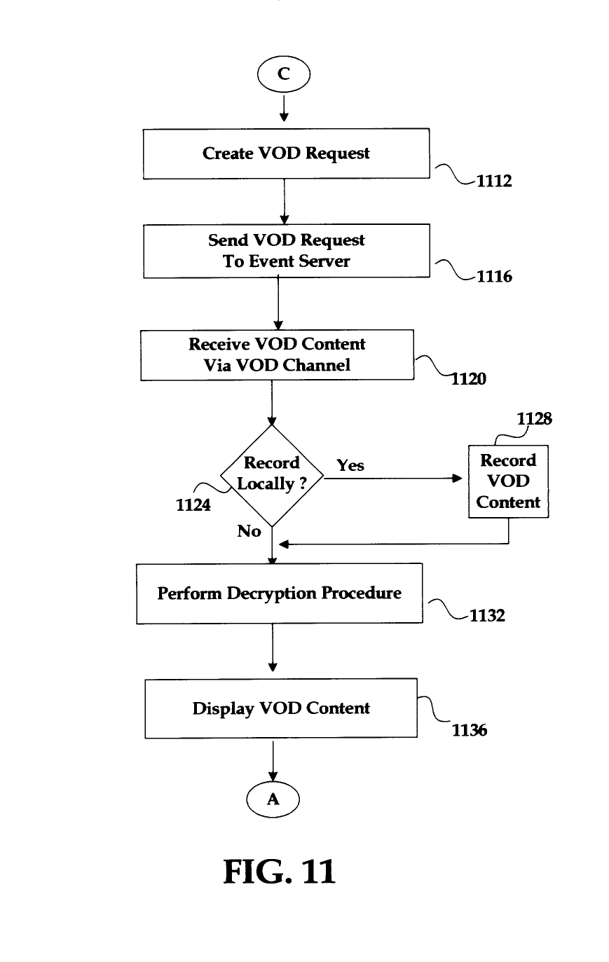

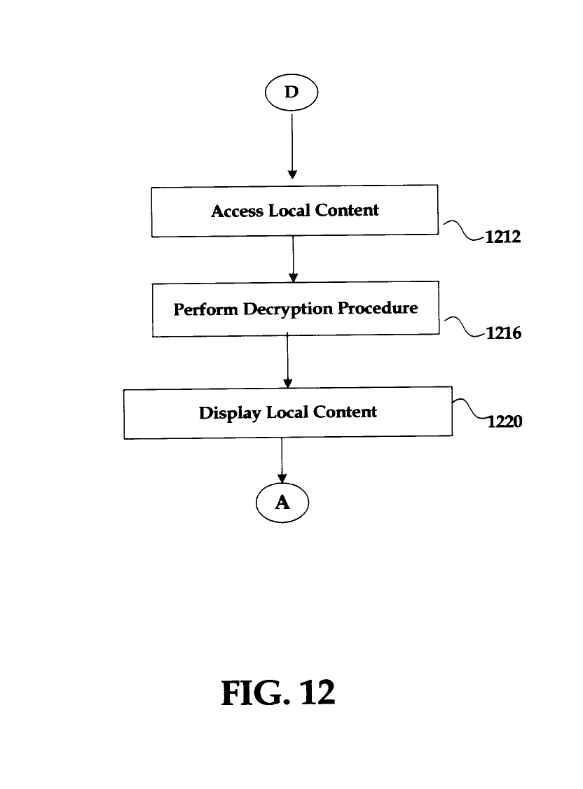

In step 920, if the system user selects a broadcast viewing mode, then the FIG. 9 process may preferably advance to letter “B” (step 1012) of FIG. 10. Similarly, if the system user selects a VOD viewing mode, then the FIG. 9 process may preferably advance to letter “C” (step 1112) of FIG. 11. In addition, if the system user selects a local viewing mode, then the FIG. 9 process may preferably advance to letter “D” (step 1212) of FIG. 12.

Referring now to FIG. 10, a flowchart of method steps for a broadcast viewing mode is shown, in accordance with one embodiment of the present invention. The FIG. 10 example is presented for purposes of illustration, and, in alternate embodiments, the present invention may readily utilize various other steps and sequences than those discussed in conjunction with the FIG. 10 embodiment.

In the FIG. 10 embodiment, in step 1012, user device 114 may preferably access a broadcast channel listing from event server 138 or any other appropriate source. In the FIG. 10 embodiment, the broadcast channel listing may preferably include channel listings and corresponding program information for one or more direct broadcasts and one or more event broadcasts, as discussed above in conjunction with FIG. 7.

In step 1016, the system user may preferably utilize user device 114 to select a particular broadcast channel for receiving video or other information from event server 138. Then, in step 1020, user device 114 may preferably become connected to the selected broadcast channel via base station 122. In step 1024, user device 114 may preferably access the broadcast content via the selected broadcast channel.

Next, in step 1028, user device 114 may preferably perform a decryption procedure to decode the accessed broadcast content. In step 1032, user device 114 may preferably display the decoded broadcast content on display 218 for viewing by the system user. Finally, the FIG. 10 process may preferably return to letter “A” of FIG. 9, and continue the video streaming procedure of FIGS. 9-12, in accordance with the present invention.

Referring now to FIG. 11, a flowchart of method steps for a VOD viewing mode is shown, in accordance with one embodiment of the present invention. The FIG. 11 example is presented for purposes of illustration, and, in alternate embodiments, the present invention may readily utilize various other steps and sequences than those discussed in conjunction with the FIG. 11 embodiment.

In the FIG. 11 embodiment, in step 1112, a system user may preferably utilize user device 114 to create a VOD request using any appropriate techniques or methods. For example, the system user may enter various types of request terms into user interface 214 (FIG. 2). Then, in step 1116, user device 114 may transmit the VOD request to event server 138.

In step 1120, event server 138 may preferably service the VOD request and responsively transmit the requested VOD content to user device 114 via a corresponding VOD channel. In step 1124, user device 114 or the system user may preferably determine whether to locally record the VOD content into device memory 216. If user device 114 or the system user determines to locally record the VOD content into device memory 216. Then, in step 1128, user device 114 may preferably record the downloaded VOD content 734 into device memory 216 as device content information 316.

In step 1132, user device 114 may preferably perform a decryption procedure to decode the accessed VOD content. In step 1136, user device 114 may preferably display the decoded VOD content on display 218 for viewing by the system user. Finally, the FIG. 11 process may preferably return to letter “A” of FIG. 9, and continue the video streaming procedure of FIGS. 9-12, in accordance with the present invention.

Referring now to FIG. 12, a flowchart of method steps for a local viewing mode is shown, in accordance with one embodiment of the present invention. The FIG. 12 example is presented for purposes of illustration, and, in alternate embodiments, the present invention may readily utilize various other steps and sequences than those discussed in conjunction with the FIG. 12 embodiment.

In the FIG. 12 embodiment, in step 1212, user device 114 may preferably access local content that has previously been stored by user device 114 into device content information 316 of device memory 216. Next, in step 1216, user device 114 may preferably perform a decryption procedure to decode the accessed local content. In step 1220, user device 114 may preferably display the decoded local content on display 218 for viewing by the system user. Finally, the FIG. 12 process may preferably return to letter “A” of FIG. 9, and continue the video streaming procedure of FIGS. 9-12, in accordance with the present invention.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for streaming event content to a system user, comprising:
an event server configured to manage said event content, said event server providing a restricted access to said event content over an electronic network, said event content including broadcast video information transmitted on one or more broadcast channels and video-on-demand information transmitted on one or more VOD channels; and
a user device configured to communicate with said event server over said electronic network by performing a wireless communications procedure, said system user choosing a selected program channel from said one or more broadcast channels and said one or more VOD channels by utilizing said user device, said user device responsively displaying selected program information from said selected program channel for viewing by said system user.

2. The system of claim 1 wherein said event content includes restricted information that is related to at least one of a specified event, an event location, and one or more participants in said specified event, and wherein said user device is implemented as at least one of a personal digital assistant device, a cellular telephone device, a computer device, and a portable wireless telecommunications device.

3. The system of claim 1 wherein said user device communicates with said event server through one or more wireless base station transceivers and one or more local area networks, said user device communicating with said event server through at least one of a first direct path from said one or more local area networks, an indirect path from said one or more local area networks through an Internet network, and a second direct path from said user device directly through said Internet network.

4. The system of claim 1 wherein said user device includes a processor, a display, a device memory, a sound module, one or more user interfaces, and input/output interfaces, said input/output interfaces including a wireless communications interface, a network interface, and a removable memory interface, said user interfaces including a program channel selector for choosing said selected program channel from said one or more broadcast channels and said one or more VOD channels.

5. The system of claim 4 wherein said device memory includes application software, an operating system, device content information, user data, a login/configuration module for providing an access code to said event server, a download module for updating said application software and other device software, a VOD module for accessing said video-on-demand information, an access rights module, a video player, a metadata module for managing ancillary data related to a particular event, a channel module, and an encryption module.

6. The system of claim 1 wherein said event server includes a processor, a display, a server memory, one or more user interfaces, and input/output interfaces, said input/output interfaces including at least one of a wireless communications interface and a network interface, said input/output interfaces including also including one or more broadcast channel interfaces and one or more VOD channel interfaces.

7. The system of claim 6 wherein said server memory includes application software, an operating system, server content information, a network manager, a login/configuration manager, an upload module for updating device application software and other device software, a storage manager, an access rights manager for managing said restricted access to said event content, a channel manager, a metadata manager for managing ancillary data related to a particular event, an encryption manager, and a VOD manager.

8. The system of claim 1 wherein said event server receives said event content from one or more video cameras, from an Internet network, and from one or more external program sources, said external program sources including at least one of a satellite program source, a cable broadcasting program source, and a distributed computer network program source, said event server locally storing said event content into a server memory device.

9. The system of claim 1 wherein said one or more broadcast channels includes one or more direct broadcast channels that each provide real-time streaming video information that is produced for a particular event by a video service provider.

10. The system of claim 1 wherein said one or more broadcast channels includes one or more event broadcast channels that each provide streaming video information that is retrieved from a local server memory by said event server, said one or more event broadcast channels including at least one of an event highlights channel, an instant replay channel, an event commentator channel, one or more alternate camera-angle channels, and a frequently-requested information channel.

11. The system of claim 1 wherein said one or more VOD channels are each allocated based upon a video-on-demand request from said system user, said one or more VOD channels including at least one of an event highlights channel, an instant replay channel, an event commentator channel, one or more alternate camera-angle channels, and one or more metadata channels for accessing ancillary information related to a particular event.

12. The system of claim 1 wherein said event server dynamically creates a new event broadcast channel when VOD requests for a particular VOD channel exceed a predetermined threshold value, said event server also notifying said user device regarding said new event broadcast channel.

13. The system of claim 1 wherein said user device includes a user interface and an input/output interface, said system user utilizing said user interface and said input/output interface for communicating with said event server to thereby choose said selected program channel from said one or more broadcast channels and said one or more VOD channels.

14. The system of claim 1 wherein said user device connects to said event server by utilizing an access code, said system user then performing a selection procedure to choose from a plurality of viewing modes, said viewing modes including a broadcast mode for viewing said one or more broadcast channels, a VOD mode for viewing said one or more VOD channels, and a local mode for viewing local content that was previously downloaded from said event server and stored into a device memory of said user device.

15. The system of claim 14 wherein said system user selects said broadcast viewing mode, said user device responsively accessing and displaying a broadcast channel listing from said event server, said system user then choosing said selected program channel by utilizing a user interface of said user device.

16. The system of claim 15 wherein said user device connects to said selected program channel, accesses said selected program information, performs a decryption procedure to decode said selected program information, and displays said selected program information for viewing by said system user.

17. The system of claim 14 wherein said system user selects said VOD viewing mode, said system user then utilizing a user interface of said user device to create a VOD request for accessing specific information from said video-on-demand information, said user device transmitting said VOD request to said event server, said event server responsively servicing said VOD request by retrieving said specific information from said video-on-demand information and providing said specific information to said user device on a corresponding one of said one or more VOD channels.

18. The system of claim 17 wherein said user device locally stores said specific information from said event server into said device memory for subsequent viewing in said local mode.

19. The system of claim 17 wherein said user device performs a decryption procedure to decode said specific information from said video-on-demand information, and displays said specific information from said video-on-demand information for viewing by said system user.

20. The system of claim 14 wherein said system user selects said local mode, said user device responsively accessing said local content, performing a decryption procedure to decode said local content, and displaying said local content for viewing by said system user.

21. A method for streaming event content to a system user, comprising the steps of:
managing said event content with an event server, said event server providing a restricted access to said event content over an electronic network, said event content including broadcast video information transmitted on one or more broadcast channels and video-on-demand information transmitted on one or more VOD channels;
performing a wireless communications procedure with a user device to communicate with said event server over said electronic network;
choosing a selected program channel from said one or more broadcast channels and said one or more VOD channels by utilizing said user device; and
displaying selected program information from said selected program channel on said user device for viewing by said system user.

22. The method of claim 21 wherein said event content includes restricted information that is related to at least one of a specified event, an event location, and one or more participants in said specified event, and wherein said user device is implemented as at least one of a personal digital assistant device, a cellular telephone device, a computer device, and a portable wireless telecommunications device.

23. The method of claim 21 wherein said user device communicates with said event server through one or more wireless base station transceivers and one or more local area networks, said user device communicating with said event server through at least one of a first direct path from said one or more local area networks, an indirect path from said one or more local area networks through an Internet network, and a second direct path from said user device directly through said Internet network.

24. The method of claim 21 wherein said user device includes a processor, a display, a device memory, a sound module, one or more user interfaces, and input/output interfaces, said input/output interfaces including a wireless communications interface, a network interface, and a removable memory interface, said user interfaces including a program channel selector for choosing said selected program channel from said one or more broadcast channels and said one or more VOD channels.

25. The method of claim 24 wherein said device memory includes application software, an operating system, device content information, user data, a login/configuration module for providing an access code to said event server, a download module for updating said application software and other device software, a VOD module for accessing said video-on-demand information, an access rights module, a video player, a metadata module for managing ancillary data related to a particular event, a channel module, and an encryption module.

26. The method of claim 21 wherein said event server includes a processor, a display, a server memory, one or more user interfaces, and input/output interfaces, said input/output interfaces including at least one of a wireless communications interface and a network interface, said input/output interfaces including also including one or more broadcast channel interfaces and one or more VOD channel interfaces.

27. The method of claim 26 wherein said server memory includes application software, an operating system, server content information, a network manager, a login/configuration manager, an upload module for updating device application software and other device software, a storage manager, an access rights manager for managing said restricted access to said event content, a channel manager, a metadata manager for managing ancillary data related to a particular event, an encryption manager, and a VOD manager.

28. The method of claim 21 wherein said event server receives said event content from one or more video cameras, from an Internet network, and from one or more external program sources, said external program sources including at least one of a satellite program source, a cable broadcasting program source, and a distributed computer network program source, said event server locally storing said event content into a server memory device.

29. The method of claim 21 wherein said one or more broadcast channels includes one or more direct broadcast channels that each provide real-time streaming video information that is produced for a particular event by a video service provider.

30. The method of claim 21 wherein said one or more broadcast channels includes one or more event broadcast channels that each provide streaming video information that is retrieved from a local server memory by said event server, said one or more event broadcast channels including at least one of an event highlights channel, an instant replay channel, an event commentator channel, one or more alternate camera-angle channels, and a frequently-requested information channel.

31. The method of claim 21 wherein said one or more VOD channels are each allocated based upon a video-on-demand request from said system user, said one or more VOD channels including at least one of an event highlights channel, an instant replay channel, an event commentator channel, one or more alternate camera-angle channels, and one or more metadata channels for accessing ancillary information related to a particular event.

32. The method of claim 21 wherein said event server dynamically creates a new event broadcast channel when VOD requests for a particular VOD channel exceed a predetermined threshold value, said event server also notifying said user device regarding said new event broadcast channel.

33. The method of claim 21 wherein said user device includes a user interface and an input/output interface, said system user utilizing said user interface and said input/output interface for communicating with said event server to thereby choose said selected program channel from said one or more broadcast channels and said one or more VOD channels.

34. The method of claim 21 wherein said user device connects to said event server by utilizing an access code, said system user then performing a selection procedure to choose from a plurality of viewing modes, said viewing modes including a broadcast mode for viewing said one or more broadcast channels, a VOD mode for viewing said one or more VOD channels, and a local mode for viewing local content that was previously downloaded from said event server and stored into a device memory of said user device.

35. The method of claim 34 wherein said system user selects said broadcast viewing mode, said user device responsively accessing and displaying a broadcast channel listing from said event server, said system user then choosing said selected program channel by utilizing a user interface of said user device.

36. The method of claim 35 wherein said user device connects to said selected program channel, accesses said selected program information, performs a decryption procedure to decode said selected program information, and displays said selected program information for viewing by said system user.

37. The method of claim 34 wherein said system user selects said VOD viewing mode, said system user then utilizing a user interface of said user device to create a VOD request for accessing specific information from said video-on-demand information, said user device transmitting said VOD request to said event server, said event server responsively servicing said VOD request by retrieving said specific information from said video-on-demand information and providing said specific information to said user device on a corresponding one of said one or more VOD channels.

38. The method of claim 37 wherein said user device locally stores said specific information from said event server into said device memory for subsequent viewing in said local mode.

39. The method of claim 37 wherein said user device performs a decryption procedure to decode said specific information from said video-on-demand information, and displays said specific information from said video-on-demand information for viewing by said system user.

40. The method of claim 34 wherein said system user selects said local mode, said user device responsively accessing said local content, performing a decryption procedure to decode said local content, and displaying said local content for viewing by said system user.

41. A computer-readable medium comprising program instructions for streaming event content to a system user by performing the steps of:
managing said event content with an event server, said event server providing a restricted access to said event content over an electronic network, said event content including broadcast video information transmitted on one or more broadcast channels and video-on-demand information transmitted on one or more VOD channels;
performing a wireless communications procedure with a user device to communicate with said event server over said electronic network;
choosing a selected program channel from said one or more broadcast channels and said one or more VOD channels by utilizing said user device; and
displaying selected program information from said selected program channel on said user device for viewing by said system user.

42. A system for streaming event content to a system user, comprising:
means for managing said event content, said means for managing providing a restricted access to said event content over an electronic network, said event content including broadcast video information transmitted on one or more broadcast channels and video-on-demand information transmitted on one or more VOD channels; and
means for performing a wireless communications procedure to communicate with said means for managing over said electronic network;
means for choosing a selected program channel from said one or more broadcast channels and said one or more VOD channels; and
means for displaying selected program information from said selected program channel for viewing by said system user.

43. A system for streaming event content to a system user, comprising:
an event server configured to manage said event content, said event server providing a restricted access to said event content over an electronic network, said event content including at least one of broadcast video information transmitted on one or more broadcast channels and video-on-demand information transmitted on one or more VOD channels; and
a user device configured to communicate with said event server over said electronic network by performing a wireless communications procedure, said system user choosing a selected program channel from said one or more broadcast channels and said one or more VOD channels.
